(19) United States
(12) Patent Application Publication
(10) Pub. No.: US 2003/0120950 A1
(43) Pub. Date: Jun. 26, 2003

(54) Dealing with a computer virus which self-propagates by email

(75) Inventor: Bernard Hunt, Redhill (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/320,270

(22) Filed: Dec. 16, 2002

(30) Foreign Application Priority Data
Dec. 22, 2001 (GB) 0130805.5

(51) Int. Cl. H04L 9/00

(52) U.S. Cl. 713/200

(57) ABSTRACT

There is disclosed a method of dealing with a computer virus which self-propagates by causing an infected computer to send an email containing the virus to another computer using an email address present in an address book of the infected computer. The method comprises the steps of (i) receiving an email suspected of having been caused to be sent by such a virus at a computer; and (ii) upon step (i), carrying out a computer automated service for dealing with such a virus, wherein the automated service is rendered either to the computer from which the email was sent or to a computer in receipt of the email other than the one in step (i). Also disclosed is a corresponding computer system and related methods.

### FIELD OF INVENTION

This invention relates to method of dealing with a computer virus or the threat of such a virus which self-propagates by causing an infected computer to send an email containing the virus to another computer using an email address present in an address book of the infected computer.

### BACKGROUND TO INVENTION

In the computing fraternity, it is common knowledge for a user to add their own email address to their address book in order to detect the existence of a virus which self-propagates in the manner described above. The rational behind this is that the user would not normally send an email to themselves, and therefore could deduce from receipt of such an email that it had been caused to be sent by such a virus in the course of self-propagation. This is a self-help solution which does not involve anyone other than the user.

It is further known to employ commercially available anti-virus software packages which enable a user to scan incoming emails for such viruses. However, whilst this solution utilizes commercial expertise embedded in the software for tackling such virus problems, it initially relies on the user purchasing and installed anti-virus software in anticipation of a future virus and subsequently relies on the user updating the anti-virus software to target newly developed viruses. If further relies on the anti-virus software provider being aware of the virus.

### OBJECT OF INVENTION

It is an object of the invention to provide an alternative method of dealing with a computer virus of the type described above or the threat of such a virus.

### SUMMARY OF INVENTION

In accordance with the present invention, such a method, especially for implementation on a computer system belonging to a commercial anti-virus software provider, comprising the steps of (i) receiving an email suspected of having been caused to be sent by such a virus at a computer; and (ii) upon step (i), carrying out a computer automated service for dealing with such a virus wherein the automated service is rendered either to the computer from which the email was sent or to another computer which received the email other than the one in step (i).

The automated service may be relatively simple such as generating an email reply containing a notification of the suspected presence of the virus. Optionally, such an email reply may also contains an invitation to procure a service or product for protecting a computer from the suspected virus, or a hyperlink thereto.

Alternatively, the automated service may be more complicated in that it may include scanning the email for the virus and, in the event that a virus is found, generating an email reply containing a notification of the confirmed presence of the virus. As with the more simple service, the such an email reply may also contains an invitation to procure a service or product for protecting a computer from the confirmed virus, or a hyperlink thereto.

In addition, in the event that a virus is found, the automated service may further comprise disinfecting from the virus either the computer from which the email was sent or to another computer which received the email. This may be done by transmitting executable code adapted to disable the virus.

Typically, the receiving computer would belong to a commercial anti-virus service provider whose email address of the anti-virus service provider is contained in an address book of the computer from which the email was sent.

Also provided in accordance with the present invention is a corresponding computer system as recited in claim 10 to claim 18 of the accompanying claims together with related methods as recited in claim 19 and claim 20.

### BRIEF DESCRIPTION OF DRAWING

The present invention will now be described, by way of example only, with reference to the accompanying schematic figure in which:

FIG. 1 depicts the computer systems of a commercial anti-virus service provider (SP) and a series of domestic users (Un), each connected to the Internet.

### DETAILED DESCRIPTION

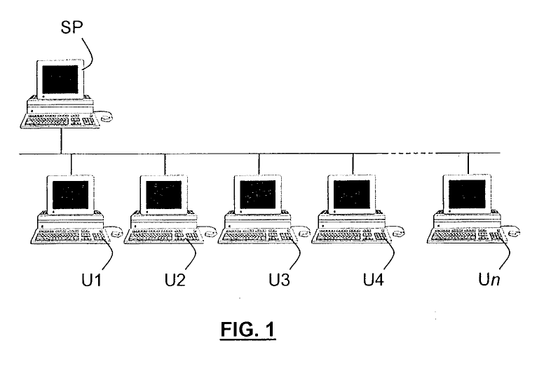

The computer systems depicted in FIG. 1, one belonging to a commercial anti-virus service provider (SP) and the others belonging to a series of domestic users (Un), are each connected to the Internet and able to transmitted email to each other via respective email addresses.

For the purposes of illustration, suppose that computer system SP is associated with the email address avsp@host.com, the domestic users are associated with the email addresses user_n@host.com and the domestic user of computer system U1 has inserted the email address avsp@host.com into the address book of the email application operating on computer system U1.

Further suppose that computer system U1 has become infected by a new virus which self-propagates by causing an infected computer to send an email containing the virus to another computer using an email address present in an address book of the infected computer. Being a new virus, one can assume that the computer system U1 has no means of identifying or disinfecting the virus by itself. Equally, the same would apply if the virus was an old virus in respect of which the user of computer system U1 had not installed or updated anti-virus protection software to protect against that virus, or installed a patch to stop the email application being so manipulated.

Upon an event occurring which prompts the virus to self-propagate, e.g. the execution of the email application, the virus instructs the email application of computer system U1 to send an email which contains the virus to all email addresses in its address book including to email address avsp@host.com associated with the computer system SP of the anti-virus service provider and email addresses user_2@host.com, user_3@host.com and user_4@host.com associated with computer systems U2, U3 and U4 respectively.

In accordance with the present invention, the computer system SP of the anti-virus service provider responds to receipt of the email from computer system U1 in accordance with either of the following examples:

### EXAMPLE 1

Based on the assumption that that the email has been caused to be sent by a virus in the course of propagation (especially valid if email address avsp@host.com is provided specifically for the purpose of identifying such viruses), computer system SP sends an automated email reply to computer system U1 which also is copied to each of the other recipients of the original email U2, U3 and U4. The automated reply comprises a notification of the suspected presence of the virus together with advertising and a related invitation to purchase generic anti-virus protection software from the anti-virus service provider. The advertising and related invitation are directed not only to the user of computer system U1 but also to the users of computer systems U2, U3 and U4 which by receiving the original email are subjected to a higher risk of infection by the virus that would otherwise be the case. If the invitation is accepted by either of the users of computer systems U1, U2, U3 or U4, the software may be transmitted directly from the anti-virus service provider to that user. Alternatively, acceptance may prompt the software, if recorded on a optical disc or other storage media, to be dispatched in the post to the user.

### EXAMPLE 2

The email is presumed to have been caused to be sent by such a virus by the very nature of it being received at email address avsp@host.com., However, there is no direct indication of what specific virus is responsible or indeed any proof that a virus was actual responsible for causing the email to be sent given that it could have been inadvertently sent by the user. To address these possibilities, the computer system SP is configured to scan the incoming email for a virus.

Computer system SP is configured to send an automated email reply in response to the email sent by computer system U1 which also is copied to each of the other recipients of the original email U2, U3. In the event that a virus is found, the automated reply comprises a notification of the confirmed presence of the virus. Conversely, if no virus is found, then the automated reply comprises a notification that no virus was found (although of course that is not to say there is none present).

Where a virus is found and identified, the automated reply may comprise advertising and a related invitation to purchase anti-virus protection software designed to specifically disinfect the identified virus.

Where a virus is found and but not identified, the automated reply may comprise advertising and a related invitation to purchase an interim anti-virus solution which may, for example, disable functionality of the email application, thereby halting the further spread of the virus until a measure can be developed to disinfect that virus.

Receiving of an email in which a virus is found and but not identified can serve as a prompt (automated or otherwise) for the anti-virus software provider to rapidly develop a counter measure to such a virus or viruses of the same type. Once developed, the anti-virus service-provider may further notified users of computer systems U1, U2 and U3 that this has been done and invite them to purchase the newly developed counter measure.

The email address avsp@host.com provided above is a general such email address which may be made available to the general public. It is conceivable that the anti-virus service provider might have dedicated email addresses for specific customers who subscribed to such an anti-virus service. This would also be likely to reduced the number of hoax or inadvertent emails sent to the email address of the anti-virus service provider.

The invention is described in the context of computers systems connected across the Internet, however, it will be appreciated that the invention will be equally applicable to other WANs, LANs or other type of network.

From reading the present disclosure, other modifications will be apparent to persons skilled in the art. Such modifications may involve other features which are already known in the design and use of computer systems and component parts thereof and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalization of one or more of those features which would be obvious to persons skilled in the art, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of dealing with a computer virus which self-propagates by causing an infected computer to send an email containing the virus to another computer using an email address present in an address book of the infected computer, the method comprises the steps of:
(i) receiving an email suspected of having been caused to be sent by such a virus at a computer; and
(ii) upon step (i), carrying out a computer automated service for dealing with such a virus
wherein the automated service is rendered either to the computer from which the email was sent or to a computer in receipt of the email other than the one in step (i).

2. A method according to claim 1 wherein the automated service comprises generating an email reply containing a notification of the suspected presence of the virus either to the computer from which the email was sent or to a computer in receipt of the email other than the one in step (i).

3. A method according to claim 2 wherein the email reply contains an invitation to procure a service or product for protecting a computer from the suspected virus, or a hyperlink thereto.

4. A method according to claim 1 wherein the automated service comprises scanning the email for the virus.

5. A method according to claim 4 wherein, in the event that a virus is found, the automated service comprises generating an email reply containing a notification of the confirmed presence of the virus either to the computer from which the email was sent or to a computer in receipt of the email other than the one in step (i).

6. A method according to claim 5 wherein the email reply contains an invitation to procure a service or product for protecting a computer from the confirmed virus, or a hyperlink thereto.

7. A method according to claim 4 wherein, in the event that a virus is found, the automated service comprises disinfecting from the virus either to the computer from which the email was sent or to a computer in receipt of the email other than the one in step (i).

8. A method according to claim 7 wherein disinfecting is done by transmitting executable code to infected computer.

9. A method according to claim 1 wherein the receiving computer belongs to a commercial anti-virus service provider and the email address of the anti-virus service provider is contained in an address book of the computer from which the email was sent.

10. A computer system configured to carry out a computer automated service for dealing with a virus which self-propagates by causing an infected computer to send an email containing the virus to another computer using an email address present in an address book of the infected computer, wherein the automated service is effected upon receipt at the computer system of an email suspected of having been caused to be sent by such a virus and rendered either to the computer from which the email was sent or to any other computer in receipt of the email.

11. A computer system according to claim 10 wherein the automated service comprises generating an email reply containing a notification of the suspected presence of the virus.

12. A computer system according to claim 11 wherein the email reply contains an invitation to procure a service or product for protecting a computer from the suspected virus or a hyperlink thereto.

13. A computer system according to claim 10 wherein the automated service comprises scanning the email for the virus.

14. A computer system according to claim 13 wherein, in the event that a virus is found, the automated service comprises generating an email reply containing a notification of the confirmed presence of the virus.

15. A computer system according to claim 14 wherein the email reply contains an invitation to procure a service or product for protecting a computer from the confirmed virus, or a hyperlink thereto.

16. A computer system according to claim 13 wherein, in the event that a virus is found, the automated service comprises disinfecting either the computer from which the email was sent or any other computer, other than the one in step (i), which received the email from the virus.

17. A computer system according to claim 16 wherein disinfecting is done by transmitting executable code adapted to protect a computer from the virus to either the computer from which the email was sent or any other computer, other than the one in step (i), which received the email from the virus.

18. A computer system according to claim 10 wherein the receiving computer belongs to a commercial anti-virus service provider and the email address of the anti-virus service provider is containing in an address book of the computer from which the email was sent.

19. A method of dealing with a computer virus which self-propagates by causing an infected computer to send an email containing the virus to another computer using an email address present in an address book of the infected computer, the method comprises the steps of:
at a computer of a commercial anti-virus service provider, receiving an email from a computer suspected of propagating such a virus and belonging to a user external to the service provider;
analyzing the email for a virus; and
in the event that a virus is found, developing a solution to prevent the future propagation of that virus or viruses of the same type.

20. A method of providing a commercial anti-virus service for dealing with a computer virus which self-propagates by causing an infected computer to send an email containing the virus to another computer using an email address present in an address book of the infected computer, the method comprises the step of:
maintaining an email account having an prescribed email address; and
inviting a user of a computer system to add the prescribed email address to an address book of the computer system.
